(19) United States
(12) Patent Application Publication
(10) Pub. No.: US 2008/0182190 A1
(43) Pub. Date: Jul. 31, 2008

(54) TONER, METHOD FOR PRODUCING TONER, AND IMAGE FORMING APPARATUS

(75) Inventor: Takeshi Arakawa, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/018,547

(22) Filed: Jan. 23, 2008

(30) Foreign Application Priority Data
Jan. 25, 2007 (JP) 2007-014867

(51) Int. Cl. G03G 9/087; G03G 15/08

(52) U.S. Cl. 430/108.7; 430/137.1; 399/53

(57) ABSTRACT

An object of the present invention is to provide a toner for electrostatic development containing core-shell type toner particles, which can decrease the amount of a toner fused onto a developing roller and a regulating blade of a developing device in a development process. An aspect of the present invention pertains to a toner comprising core-shell type toner particles and an external additive, wherein the core-shell type toner particle has a core particle and a shell layer coating the core particle, the core particle contains a binder resin, a releasant and a coloring material, the shell layer has at least one small depressed portion on the surface there of, and the external additive is dominantly distributed in the one or more small depressed portion(s).

### BACKGROUND OF THE INVENTION

1. Field of the Invention

The present invention relates to a toner used for formation of an image by electrophotographic method, and an image forming apparatus using an electrophotographic method.

2. Description of the Related Art

As a polymerized toner contained in a developer which is used in copying machines and printers using an electrophotographic method, core-shell type toner particles are proposed (for example, Japanese Unexamined Patent Publication (Kokai) No. 2002-91060 (Patent Document 1) and Japanese Unexamined Patent Publication (Kokai) No. 10-177278 (Patent Document 2)). The core-shell type toner particles are excellent in fixing property and storage stability (blocking resistance).

The core-shell type toner particle is formed by coating a core particle containing a binder resin having a low glass transition temperature (T_{g}), a coloring material, a releasant and a charge control agent with a shell layer made of a resin having a high glass transition temperature. The core-shell type toner particle is also referred to as capsule type toner particle.

In a toner containing core-shell type toner particles, a shell layer preferably has a large thickness so as to obtain a toner having high storage stability. In contrast, a shell layer preferably has a small thickness so as to obtain a toner having high fixing property. Namely, there exists a trade-off relationship between storage stability and fixing property adjusted by the thickness of the shell layer.

Patent Document 1 and Patent Document 2 disclose core-shell type toner particles having high storage stability even if the shell layer has a small thickness. However, when the shell layer has a small thickness, there arises a problem that a toner is easily fused onto a developing roller and/or a regulating blade of a developing device in a development process. Particularly, in a development process using a non-magnetic one-component toner developing method, there arises a problem that the toner is fused more easily. This is considered to be since in the development process using the non-magnetic one-component toner developing method, toner particles are subjected to high mechanical stress at high temperature, and thus a low melting point component in the toner particles is fused and exposed to the surface. Also, among developing devices using the non-magnetic one-component toner developing method, the toner in a developing device using a full toner detection method capable of maintaining the amount of a toner in a toner tank to a fixed amount by appropriately feeding the toner from the outside is easily subjected to mechanical stress as compared with an expendable cartridge type developing device, thus causing a problem that fusion of the toner easily occurs.

### SUMMARY OF THE INVENTION

An object of the present invention is to provide a toner for electrostatic development containing core-shell type toner particles, which can decrease the amount of a toner fused onto a developing roller and a regulating blade of a developing device in a development process.

An aspect of the present invention pertains to a toner comprising core-shell type toner particles and an external additive, wherein the core-shell type toner particle has a core particle and a shell layer coating the core particle, the core particle contains a binder resin, a releasant and a coloring material, the shell layer has at least one small depressed portion on the surface there of, and the external additive is dominantly distributed in the one or more small depressed portion(s).

Objects, features, aspects and advantages of the present invention become more apparent from the following detailed description and accompanying drawings.

### BRIEF DESCRIPTION OF THE DRAWINGS

FIG. 1 is a schematic sectional view of a toner according to one embodiment of the present invention, and a partially enlarged view of the schematic sectional view.

FIG. 2 is a schematic view showing a constitution of an image forming apparatus using a toner of one embodiment of the present invention.

### DETAILED DESCRIPTION OF THE PREFERRED EMBODIMENTS

Embodiments of the present invention are now described in detail. However, the present invention is not limited to these Embodiments.

### Embodiment 1

As described above, when a core-shell type toner particle having a thin shell layer is used as a toner component in a development process using a non-magnetic one-component toner developing method, there arose a problem that a toner is easily fused onto a developing roller and/or a regulating blade of a developing device. The mechanism of generation of fusion is considered to be that, in the development process, when the toner particle is subjected to high mechanical stress at high temperature, a component having a low melting point such as a releasant contained in the core particles is exposed on the surface of the shell layer and the exposed component is fused, and thus the toner is fused onto the developing roller and the regulating blade.

In polymerization of a core-shell type toner particle, when a component having high hydrophobicity such as a releasant exists in the vicinity of the surface of core particle, the thickness of the shell layer at the portion thereof decreases and a small depressed portion is formed on the surface of the shell layer. The reason is considered that a monomer which forms a shell layer having comparatively high hydrophilicity has low affinity with a component having high hydrophobicity such as a releasant. In other words, the hydrophobic component in the vicinity of the surface of the core particle inhibits formation of the shell layer. Therefore, when the toner particle is subjected to mechanical stress, the releasant in the core particle is easily exposed at the portion where the shell layer has a small thickness. Furthermore, since the releasant is dominantly distributed in the vicinity of the surface of the core particle directly under the portion where the small depressed portion is formed, the releasant is exposed more easily from the vicinity of the small depressed portion.

It is considered that, in the toner of the present embodiment, when an external additive is dominantly distributed in the small depressed portion formed on the surface of the shell layer of a core-shell type toner particle, oozing of a component such as a releasant on the surface of the small depressed portion is suppressed and also the oozed component is adsorbed or held by the external additive. It is also considered that the external additive distributed dominantly in the small depressed portion relieves stress applied to the small depressed portion. As a result, according to the toner of the present embodiment, the amount of the toner fused onto the developing roller and the regulating blade is decreased by suppressing oozing of a low melting point component such as a releasant.

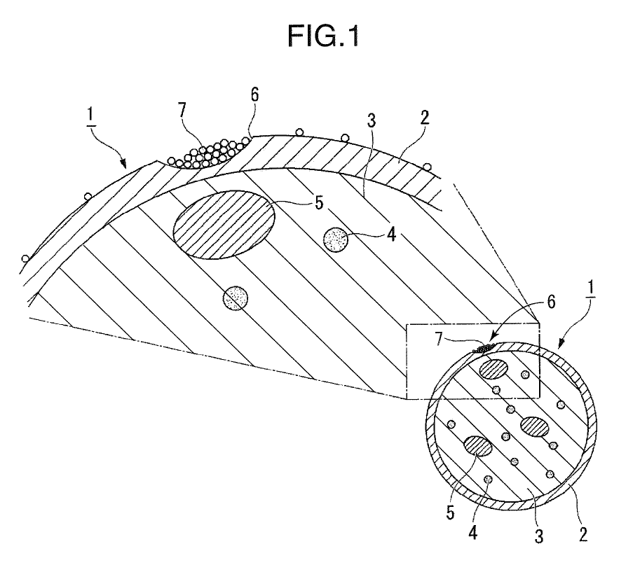

FIG. 1 shows a schematic view of a toner of the present embodiment and a partially enlarged view thereof. The toner shown in FIG. 1 contains a toner particle 1, and external additive 7 adhered onto the toner particle 1. The toner particle 1 has a core-shell structure in which a core particle containing a binder resin 3, a coloring material 4 and a releasant 5 is coated with a shell layer 2. The core particle contains the binder resin 3 as a main component and also contains a coloring material 4 and a releasant 5. If necessary, the core particle may contain other components such as a charge control agent. In the core particle, the coloring material 4 and the releasant 5 are dispersed. The shell layer 2 is formed of a resin having a higher glass transition temperature than that of the binder resin 3, and has a small depressed portion 6 on the surface. An External additive 7 is dominantly distributed in the small depressed portion 6.

As shown in FIG. 1, in the core-shell type toner particle 1, the releasant 5 is contained in the core particle. A monomer having low hydrophobicity which forms the shell layer 2 has low affinity with the releasant 5 having high hydrophobicity. Therefore, when the releasant 5 exists in the vicinity of the surface of the core particle in a polymerization step of shell layer 2, a monomer component which forms the shell layer 2 shows low affinity with the surface layer portion. As a result, as shown in the schematic view of FIG. 1, the thickness of the shell layer with which the surface layer portion of core particle containing the releasant 5 distributed dominantly therein decreases to form the small depressed portion 6. This small depressed portion 6 corresponds to the portion where the shell layer has a small thickness, and the releasant 5 locally exists directly under the portion. Therefore, it is considered that the releasant 5 easily oozes from the vicinity of the small depressed portion 6.

It is considered that, in the toner of the present embodiment, when the particles of the external additive 7 is dominantly distributed on the surface of the small depressed portion 6, oozing of the releasant 5 in the vicinity of the small depressed portion 6 is suppressed and the oozed releasant 5 is adsorbed or held by the external additive 7. It is also considered that the particles of the external additive 7 distributed dominantly in the small depressed portion 6 relives mechanical stress applied to the small depressed portion 6. As described above, it is considered that oozing can be suppressed without externally adding a large amount of the external additive 7 by dominantly distributing the external additive 7 in the small depressed portion 6.

The toner particle in the present embodiment has a core-shell type structure, and also has a small depressed portion or portions on the surface of the shell layer.

The average particle size of the toner particles is preferably from 4 to 10 μm, and more preferably from about 5 to 8 μm, in view of obtaining an image having excellent quality.

The average thickness of the shell layer is preferably within a range from 0.001 to 1.0 μm, more preferably from 0.003 to 0.5 μm, and particularly preferably from 0.005 to 0.2 μm. When the shell layer has too large a thickness, fixing property of the toner tends to deteriorate. In contrast, when the shell layer has too small a thickness, storage stability of the toner tends to deteriorate.

The average particle size of the toner is measured using a particle size distribution meter (Multisizer 3, manufactured by Beckman Coulter, Inc.,) and the thickness of the shell layer is a value obtained by calculating the difference between the particle size of core particles measured preliminarily and the particle size of toner particles after forming the shell layer.

It is preferred that about one to five small depressed portions formed on the surface of the shell layer exist on the surface of the shell layer per one toner particle in view of efficiently suppressing oozing of a releasant. Regarding the size of the small depressed portion(s), the average diameter is preferably within a range from 0.5 to 2.5 μm and the thickness is within a range from about 0.1 to 1 μm, in view of sufficiently maintaining fixing property of the toner.

The number of the small depressed portions and the size of the small depressed portion(s) can be confirmed by an image observed using a scanning electron microscope (SEM). The diameter can be measured by measuring the length of the major axis from a microscope image, while the length of the small depressed portion(s) can be measured from a difference between the focal distance of the bottom of a small depressed portion and the focal distance of a portion other than a small depressed portion.

The external additive may exist only in the small depressed portion, or exists in the small depressed portion and the surface other than the surface of the small depressed portion as long as it is dominantly distributed in the small depressed portion. As used herein, the expression “dominantly distributed in the small depressed portion” means that “the number of particle per unit area of the external additive existing in the small depressed portion is more than the number of particle per unit area of the external additive existing on the surface other than the small depressed portion”.

Specifically, the number of particle per unit area of the external additive existing in the small depressed portion is preferably at least two times more than the number of particle per unit area of the external additive existing on the surface other than the surface of the small depressed portion in view of a high effect of decreasing the amount of a toner fused onto a developing roller and a regulating blade in a development process.

A Core-shell type toner particle in the present embodiment is now described in more detail.

The toner particle of the present embodiment has a core-shell structure, and a shell layer coating the core particle. The core particle contains a binder resin as a main component, and also contains other components such as a coloring material, a releasant and, if necessary, a charge control agent. The shell layer is formed of a resin having a higher glass transition temperature than that of the binder resin.

The binder resin to be used is not specifically limited as long as it is a resin having a lower glass transition temperature than that of a resin which forms the shell layer. The glass transition temperature of the binder resin is preferably within a range from 40 to 80° C., and more preferably from 50 to 70° C., in view of sufficiently maintaining fixing property. The glass transition temperature of the resin which forms the shell layer is preferably within a range from 50 to 120° C., more preferably from 60 to 110° C., and particularly preferably from 80 to 105° C., in view of sufficiently maintaining storage stability.

The toner particles of the present embodiment are produced, for example, by a suspension polymerization method or an emulsion polymerization method.

A method for producing toner particles using a suspension polymerization method is now described in detail as a typical example.

In the production of toner particles using the suspension polymerization method, a core particles formation step, a shell layer formation step and a toner particles collection step are included. The core particles formation step is a step of forming a suspension containing core particles by suspension polymerization of a mixture which forms a core (hereinafter simply referred to as a core mixture) containing a monomer which forms a binder resin, a releasant and a coloring material in an aqueous medium. The shell layer formation step is a step of forming a shell layer by adding a monomer which forms a shell (hereinafter simply referred to as a shell monomer) to the suspension, followed by suspension polymerization. The toner particles collection step is a step of collecting toner particles by filtering, washing and drying the resulting polymerized particles.

### (Core Particles Formation Step)

Core particles are obtained by suspension polymerization of a core mixture containing a monomer for formation of a binder resin (hereinafter simply referred to as a binder resin monomer), a coloring material and a releasant. More specifically, a binder resin monomer, a molecular weight modifier, a polymerization initiator, a releasant, a coloring material and a charge control agent are uniformly mixed to prepare a core mixture and the resulting core mixture is dispersed in an aqueous medium containing a dispersion stabilizer to form microdroplets, and then the dispersion is polymerized at a predetermined temperature to obtain core particles.

Examples of the binder resin monomer include a monovinyl monomer, a macromonomer and a crosslinkable monomer. The glass transition temperature of the resulting binder resin is adjusted by appropriately adjusting the kind and the mixing ratio of the monovinyl monomer, the macromonomer and the crosslinkable monomer. The glass transition temperature is preferably within a range from 40 to 80° C., and more preferably from 50 to 70° C. The glass transition temperature of the polymer is a calculated value obtained by calculating from the composition of the binder resin monomer.

Specific examples of the monovinyl monomer include an aromatic vinyl monomer such as styrene, vinyltoluene, or α-methylstyrene; (meth)acrylic acid; a derivative of (meth)acrylic acid, such as methyl(meth)acrylate, ethyl(meth)acrylate, propyl(meth)acrylate, butyl(meth)acrylate, 2-ethylhexyl(meth)acrylate, dimethylaminoethyl(meth)acrylate, or (meth)acrylamide; and a monoolefin monomer such as ethylene, propylene, or butylene. (Meth)acrylic acid means acrylic acid or methacrylic acid. These monovinyl monomers may be used alone or in combination. Of these monovinyl monomers, an aromatic vinyl monomer alone or a combination of an aromatic vinyl monomer and a derivative of (meth)acrylic acid is preferably used.

The macromonomer is an oligomer or polymer having an average molecular weight of about 1,000 to 30,000, which has a radically active functional group at the end of a molecular chain. Specific examples of the macromonomer include a polymer obtained by polymerizing styrene, a styrene derivative, a methacrylate ester, an acrylate ester or acrylonitrile alone or a combination of two or more kinds of them; and a macromonomer having a polysiloxane skeleton. Of these macromonomers, a hydrophilic macromonomer, for example, a polymer obtained by polymerizing a methacrylate ester or an acrylate ester alone or a combination of two or more kinds of them is particularly preferable.

The crosslinkable monomer is a monomer having two or more radically active functional groups and is used to enhance storage stability of toner particles. Specific examples of the crosslinkable monomer include an aromatic divinyl compound such as divinylbenzene, divinylnaphthalene, or a derivative thereof; a diethylenically unsaturated carboxylate ester such as ethylene glycol dimethacrylate or diethylene glycol dimethacrylate; a divinyl compound such as N,N-divinylaniline or divinylether; and a compound having three or more vinyl groups. These crosslinkable monomers can be used alone or in combination.

The content of the crosslinkable monomer is preferably within a range from 0.01 to 5 parts by mass, and more preferably from 0.05 to 2 parts by mass, based on 100 parts by mass of the monovinyl monomer.

Specific examples of the molecular weight modifier include mercaptanes such as t-dodecylmercaptane, n-dodecylmercaptane, n-octylmercaptane, and 2,2,4,6,6-pentamethylheptane-4-thiol; and halogenated hydrocarbons such as carbon tetrachloride and carbon tetrabromide. The molecular weight modifier may be preliminarily added to the monomer composition, or may be added to the suspension of the monomer composition before or during polymerization.

Specific examples of the polymerization initiator include a persulfate such as potassium persulfate or ammonium persulfate; an azo compound such as 4,4′-azobis(4-cyanovaleric acid), 2,2′-azobis[2-methyl-N-(2-hydroxyethyl)propionamide], 2,2′-azobis(2-amidinopropane)dihydrochloride, 2,2′-azobis(2,4-dimethylvaleronitrile), 2,2′-azobisisobutyronitrile, or 2,2′-azobis(2-methylpropionate); a peroxide such as di-t-butyl peroxide, dicumyl peroxide, lauroyl peroxide, benzoyl peroxide, t-butylperoxy-2-ethyl hexanoate, t-hexylperoxy-2-ethyl hexanoate, t-butyl peroxypivalate, di-isopropyl peroxydicarbonate, di-t-butyl peroxyisophthalate, 1,1′,3,3′-tetramethylbutylperoxy-2-ethylhexanoate, or t-butyl peroxyisobutyrate; and a redox initiator obtained by using the polymerization initiator in combination with a reducing agent.

Of these polymerization initiators, an oil soluble polymerization initiator, which is soluble in the monovinyl monomer, is preferable. If necessary, a water soluble polymerization initiator may be used in combination.

The polymerization initiator may be preliminarily added to a binder resin monomer, or may be added to the suspension of the monomer composition before or during polymerization so as to suppress a rapid polymerization reaction.

The releasant is mixed so as to improve fixing property of the toner and to suppress an offset phenomenon and an image smearing phenomenon.

Specific examples of the releasant include a wax and a polyfunctional ester compound. Specific examples of the wax include polyolefin waxes such as low molecular weight polyethylene, low molecular weight polypropylene, and low molecular weight polybutylene; vegetable natural waxes such as candelilla wax, carnauba wax, Japan wax, and jojoba oil; petroleum-based waxes such as paraffin, microcrystalline, and petrolactam or a modified wax thereof; and a synthetic wax such as Fischer-Tropsch wax. Specific examples of the polyfunctional ester compound include pentaerythritol tetramyristate, pentaerythritol tetrapalmitate, and dipentaerythritol hexamyristate. These compounds may be used alone or in combination. Of these waxes, a low molecular weight polyolefin wax, a synthetic wax, an end modified polyolefin wax, a petroleum-based wax and a polyfunctional ester compound are particularly preferable in view of easily forming a small depressed portion on the surface of the shell layer.

The content of the releasant is within a range from 1 to 10 parts by mass, and more preferably from 1 to 5 parts by mass, based on 100 parts by mass of the binder resin monomer. When the content of the releasant is too small, a small depressed portion is not easily formed on the surface of the shell layer, and also a high temperature offset phenomenon and an image smearing phenomenon tend to not be sufficiently suppressed. In contrast, when the content of the releasant is too large, storage stability tends to deteriorate.

As the coloringmaterial, for example, pigments or dyes, which have hitherto been used as a coloring material of a toner, are used without any limitation. Specific examples of the pigment include black pigments such as carbon black, acetylene black, and aniline black; yellow pigments such as Chrome Yellow, Zinc Yellow, Cadmium Yellow, Yellow Iron Oxide, Nables Yellow, Naphthol Yellow S, Hansa Yellow G, Benzidine Yellow G, Quinoline Yellow Lake, Permanent Yellow NCG, Tartrazine Lake, and Yellow CI Pigment Yellow; orange pigments such as Chrome Orange, Molybdenum Orange, Pyrazolone Orange, Vulcan Orange, and Indathrene Brilliant Orange GK; red pigments such as Blood Red, Cadmium Red, Red Lead, Cadmium Mercury Sulfide, Permanent Red 4R, Lithol Red, Pyrazolone Red, Watching Red Calcium Salt, Lake Red D, Brilliant Carmine 6B, Eosine Lake, Rhodamine Lake B, Alizarin Lake, and Magenta CI Pigment Red; violet pigments such as Manganese Violet, Fast Violet B, and Methyl Violet Lake; blue pigments such as Prussian Blue, Cobalt Blue, Alkali Blue Lake, Victoria Blue Lake, Phthalocyanine Blue, and Fast Skyblue; green pigments such as Chromium Green, Chromium Oxide, Pigment Green B, and Malachite Green Lake; white pigments such as zinc white, titanium oxide, antimony white, and zinc sulfide; and extender pigments such as barite powder, barium carbonate, clay, silica, white carbon, and alumina white.

As the charge control agent, for example, a metal complex of an organic compound having a carboxyl group or a nitrogen-containing group, a metal-containing dye, nigrosin and a charge control resin are used. Specific examples of the charge control agent include charge control agents such as BONTRON N-01 (manufactured by Orient Chemical Industries, Ltd.), NIGROSIN BASE EX (manufactured by Orient Chemical Industries, Ltd.), SPIRON BLACK TRH (manufactured by Hodogaya Chemical Co., Ltd), T-77 (manufactured by Hodogaya Chemical Co., Ltd), BONTRON S-34 (manufactured by Orient Chemical Industries, Ltd.), BONTRON E-81 (manufactured by Orient Chemical Industries, Ltd.), BONTRON E-84 (manufactured by Orient Chemical Industries, Ltd.), BONTRON E-89 (manufactured by Orient Chemical Industries, Ltd.), BONTRON F-21 (manufactured by Orient Chemical Industries, Ltd.), COPY CHARGE NX VP434 (manufactured by Clariant Co.), COPY CHARGENEG VP2036 (manufactured by Clariant Co.), TNS-4-1 (manufactured by Hodogaya Chemical Co., Ltd), TNS-4-2 (manufactured by Hodogaya Chemical Co., Ltd), LR-147 (manufactured by Japan Carlit Co., Ltd.), and COPY BLUE PR (manufactured by Clariant Co.); and charge control resins such as a quaternary ammonium (salt) group-containing copolymer and a sulfonic acid group-containing copolymer. When the charge control resin is used as the charge control agent, it may be mixed as a master batch obtained by preliminarily kneading a coloring material with a charge control resin.

A binder resin monomer, a molecular weight modifier, a releasant, a coloring material and a charge control agent are uniformly mixed and also a polymerization initiator is added to prepare a mixture. The resulting mixture is disperse in an aqueous medium containing a dispersion stabilizer to form microdroplets, and thus a suspension used to polymerize core particles is obtained.

As the aqueous medium, for example, water such as ion-exchange water, or water containing a hydrophilic solvent such as alcohol added therein is used.

As the dispersion stabilizer, for example, a colloid of a poorly water soluble metal compound is preferably used. Specific examples of the poorly water soluble metal compound include a sulfate such as barium sulfate or calcium sulfate; a carbonate such as barium carbonate, calcium carbonate, or magnesium carbonate; a phosphate such as calcium phosphate; a metal oxide such as aluminum oxide or titanium oxide; and a metal hydroxide such as aluminum hydroxide, magnesium hydroxide, or ferric hydroxide. The amount of the dispersing agent to be added is preferably within a range from 0.1 to 20 parts by mass based on 100 parts by mass of the monomer for a binder resin.

The method of dispersing a component in an aqueous medium includes, for example, a method for preparing a suspension by adding the above respective components in an aqueous medium and stirring so as to form droplets having a volume average particle size of about 50 to 1,000 μm using a high-speed rotary shear type stirrer.

Next, the resulting suspension is charged in a polymerization reactor and then polymerized by heating.

The polymerization reaction temperature is preferably within a range from 5 to 120° C., and more preferably from 35 to 95° C. When the polymerization reaction temperature is too low, an active high polymerization initiator must be used and thus it becomes difficult to control the polymerization reaction. In contrast, when the polymerization reaction temperature is too high, a component having a low melting point is bled on the surface of toner particles, and thus storage stability tends to deteriorate.

A suspension containing core particles comprising a binder resin and a releasant and a coloring material dispersed in the binder resin is obtained by the polymerization reaction.

### (Shell Layer Formation Step)

The shell layer formation step is a step of forming a shell layer by adding a shell monomer to a suspension containing core particles, followed by suspension polymerization.

As the shell monomer, for example, a monomer which is the same monomer component as that used in the binder resin monomer and enables the T_{g} of the resulting resin to be higher than the T_{g} of the binder resin, is used. As described above, the T_{g} of the resin which forms the shell layer is adjusted to a higher temperature than that of the T_{g} of the binder resin so as to maintain storage stability of the toner.

The T_{g} of the resin which forms a shell layer is preferably a temperature which is 10° C., more preferably 20° C., and particularly preferably 30° C., higher than the T_{g} of the binder resin in view of good balance between storage stability and fixing property.

The T_{g} of the shell layer is not specifically limited as long as it is higher than the T_{g} of the binder resin. Specifically, the T_{g} of the shell layer is preferably within a range from 50 to 120° C., more preferably from 60 to 110° C., and particularly preferably from 80 to 105° C. The monomer which forms a resin having such a T_{g} includes, for example, a monomer containing styrene or methyl methacrylate as a main component.

A mixing ratio of a core monomer to a shell monomer, (core monomer/shell monomer), is within a range from 40/60 to 99.9/0.1, more preferably from 60/40 to 99.7/0.3, and particularly preferably from 80/20 to 99.5/0.5, in terms of mass ratio. When the content of the shell monomer is too small, storage stability of the toner tends to deteriorate. In contrast, when the content of the shell monomer is too large, fixing property of the toner tend to deteriorate.

The shell layer is formed by adding a dispersion containing a shell monomer or a shell monomer dispersed in an aqueous medium to a suspension containing core particles, followed by suspension polymerization for a predetermined time.

A water soluble polymerization initiator is preferably added upon the addition of a shell monomer so as to efficiently form a shell layer.

Specific examples of the water soluble polymerization initiator include a persulfate such as potassium persulfate or ammonium persulfate; and an azo compound such as 2,2′-azobis[2-methyl-N-(2-hydroxyethyl)propionamide] or 2,2′-azobis-[2-methyl-N-[1,1-bis(hydroxymethyl)ethyl]propionamide].

Thus, a dispersion containing core-shell type particles dispersed therein is obtained.

### (Toner Particles Collection Step)

The toner particles collection step is a step of collecting toner particles by filtering a dispersion containing the resulting core-shell type particles, and washing and drying the resulting core-shell type particles.

The filtration method and the washing method are not specifically limited. For example, a method of simultaneously filtering and washing the core-shell type particles using a vacuum type belt filter is employed.

After the washing step, the core-shell type particles are collected in a wet state and then dried by a conventional method. Through these steps, dried core-shell type toner particles are obtained. In the filtration and washing steps, the dispersion obtained in the polymerization step may be used as is, and ion-exchange water may be added so as to adjust the concentration of toner particles. Also, acid washing or alkali washing may be performed according to the kind of dispersion stabilizer so as to remove the dispersion stabilizer through solubilization. For example, when a colloid of a poorly water soluble metal hydroxide such as magnesium hydroxide is used as the dispersion stabilizer, the dispersion is acidified by adding an acid such as dilute sulfuric acid, thereby dissolving the colloid in an aqueous medium.

### (External Addition Treatment Step)

A toner is obtained by mixing toner particles obtained through the respective steps with an external additive, followed by a stirring treatment.

Specific examples of the external additive are fine particles such as silica fine particles, alumina fine particles, tin oxide fine particles, titanium oxide fine particles and strontium oxide fine particles. These external additives may be used alone or in combination. Of these external additives, silica fine particles are preferable in view of an excellent effect of improving charge ability and fluidity, and the effect of effectively relieving stress applied to toner particles.

The average particle size of the external additive is not specifically limited, but is preferably within a range from 5 to 30 nm, and more preferably from 10 to 20 nm.

The amount of the external additive to be added is preferably within a range from 1 to 10 parts by mass, and more preferably from 1 to 5 parts by mass, based on 100 parts by mass of toner particles. When the amount of the external additive is too small, fluidity of the toner tends to deteriorate. In contrast, when the amount of the external additive is too large, fixing property tends to deteriorate.

The external addition treatment in the present embodiment is performed by a method of dominantly distributing an external additive in the small depressed portion (s) existing on the surface of the shell layer of core-shell type toner particles by subjecting toner particles to a stirring treatment for a long time using a shear force which suppresses embedding of the external additive. It is possible to obtain a toner in which the external additive is dominantly distributed in the small depressed portion(s) by such an external addition treatment.

For example, the external addition treatment is performed by stirring a mixture of toner particles and an external additive under the conditions where low shear is applied, using a Henshel mixer equipped with a low shear type blade, for example, stirring at a circumferential speed of preferably from 10 to 30 m/s, more preferably from about 10 to 20 m/s, preferably for 5 to 30 minutes, and more preferably 10 to 20 minutes.

When the shear force is too large, the external additive tends to be embedded in the toner particle. When the shear force is small and the stirring treatment time is too short, the external additive may not be dominantly distributed in the small depressed portion(s).

The resulting toner of the present embodiment can be preferably used as a non-magnetic one-component toner. The toner can be particularly preferably used as a non-magnetic one-component toner for an image forming apparatus equipped with a non-magnetic one-component toner developing device using a full toner detection method of controlling the amount of a toner in a toner tank to a fixed amount.

### Embodiment 2

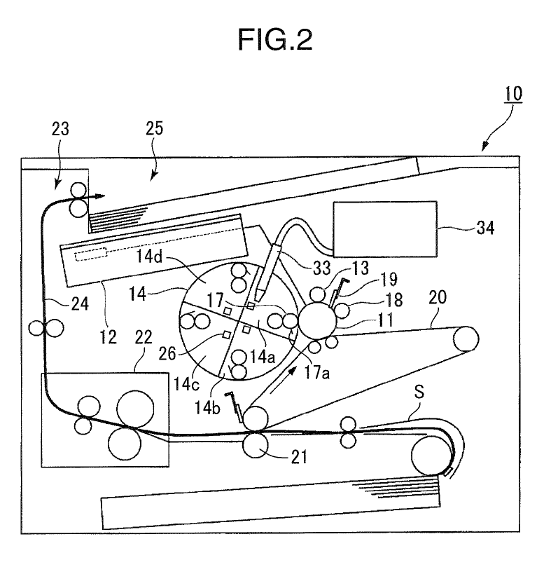

In the present embodiment, as an example of an image forming apparatus using the toner of Embodiment 1, an image forming apparatus using a non-magnetic one-component toner developing method, equipped with a developing device using a full toner detection method of controlling the amount of a toner in a toner tank to a fixed amount is described in detail with reference to FIG. 2.

An image forming apparatus 10 of the present embodiment shown in FIG. 2 comprises a photoconductor drum 11 in which an electrostatic latent image is formed on the surface; a laser scanning unit 12 which sends data to be the source of the electrostatic latent image into the photoconductor drum 11 in the form of laser light; a charging member 13 which charges the photoconductor drum 11; a rotary developing device 14 and a developing roller 17, which stir a toner and appropriately feed the toner to the photoconductor drum 11; a cleaning rubbing member 18 and a cleaning device 19, which removes the residual toner of the photoconductor drum 11; a toner container 34 which feeds the toner to the rotary developing device 14; and a feed pipe 33 which feeds a fixed amount of the toner to the rotary developing device 14 from the toner container 34. In the image forming apparatus 10, the toner of Embodiment 1 is encased in a toner container 34.

Next, an image forming process using an image forming apparatus 10 is described.

The surface of the photoconductor drum 11 is uniformly charged by the charging member 13 while rotationally driving. Then, an electrostatic latent image is formed on the surface of the photoconductor drum 11 by exposing the surface of the photoconductor drum 11 by the laser scanning unit 12 based on predetermined image signals.

A toner image is formed on the surface of the photoconductor drum 11 by feeding a toner onto the surface of photoconductor drum 11 on which an electrostatic latent image is formed, using the rotary developing device 14. Then, the toner image is transferred onto a transfer belt 20 from the photoconductor drum 11. Then, a paper S is conveyed to a transfer roller 21, where the toner image formed on the surface of the transfer belt 20 is transferred onto the paper S by the transfer roller 21. The toner image transferred onto the paper S is conveyed to the fixation unit 22, where the toner image is fixed.

After fixation, the paper S is conveyed to a paper ejection tray 25 from a paper ejection unit 23 by a conveyor belt 24.

The rotary developing device 14 is provided with toner tanks 14a, 14b, 14c and 14d which encase various black, magenta, cyan and yellow toners. The toner encased in the toner tank is supported on the surface of the rotating developing roller 17 and fed onto the surface of the photoconductor drum 11. The thickness of the toner supported on the developing roller is regulated by a regulating blade 17a.

Each toner tank is provided with a full toner detection sensor 26 for detecting a toner residual amount in the toner tank. When the full toner detection sensor 26 detects that the toner residual amount is a predetermined amount or less, a toner is fed to each toner tank from a feed pipe 33 through a toner container 34.

Since the image forming apparatus 10 is provided with the rotary developing device 14, toner particles are easily exposed to mechanical stress produced by rotation of the developing device 14 under a high temperature environment in a development process. Also in the image forming apparatus such as the image forming apparatus 10 in which the toner is exposed to high temperature and high stress, fusion of the toner onto the developing roller 17 and the regulating blade 17a in the development process can be suppressed by using the toner of Embodiment 1.

### EXAMPLES

The present invention is now described in detail by way of examples, but the present invention is not limited thereto.

### Example 1

### (Production of Toner Particles)

80 parts by mass of styrene, 20 parts by mass of n-butyl acrylate, 0.6 parts by mass of divinylbenzene, 0.25 parts by mass of a polymethacrylic acid ester macromonomer (trade name: AA6, Tg: 94° C., manufactured by TOAGOSEI Co., Ltd.) and 3 parts by mass of a low molecular weight polypropylene (releasant, weight average molecular weight: 36000, number average molecular weight: 8000) were mixed to prepare a mixed monomer solution. To the mixed monomer solution, 12 parts by mass of a coloring material master batch, 1 part by mass of t-dodecylmercaptane (molecular weight modifier) and 10 parts by mass of dipentaerythritol hexamyristate (releasant) were added and then dispersed at room temperature using a beads mill to obtain a core mixture. The coloring material master batch was produced by melt-kneading 100 parts by mass of a magenta pigment (trade name: C.1. Pigmentred 122, manufactured by Clariant Co.), 100 parts by mass of a charge control resin, 24 parts by mass of methyl ethyl ketone and 6 parts by mass of methanol. The charge control resin is a copolymer having a weight average molecular weight of 20,000 and Tg of 62° C., comprising 82% by mass of styrene, 11% by mass of butyl acrylate and 7% by mass of 2-acrylamide-2-methylpropanesulfonic acid.

A water dispersion of a shell monomer was prepared by mixing 43 parts by mass of methyl methacrylate, which is a shell monomer, and 65 parts by mass of ion-exchange water with stirring. The T_{g} of the methyl methacrylate resin is 105° C. in terms of a calculated value.

Meanwhile, an aqueous solution prepared by dissolving 17 parts by mass of magnesium chloride in 230 parts by mass of ion-exchange water was encased in a stirring tank. Then, an aqueous solution prepared by dissolving 10.3 parts by mass of sodium hydroxide in 50 parts by mass of ion-exchange water was gradually added in the stirring tank to obtain a dispersion containing a magnesium hydroxide colloid (dispersion stabilizer).

Next, the core mixture was added in the stirring tank, followed by stirring until uniform droplets are formed. Furthermore, 5 parts by mass of t-butylperoxy-2-ethyl hexanoate (trade name: PERBUTYL O, manufactured by NOF CORPORATION) was added as a polymerization initiator, followed by stirring at high speed using a high-speed rotary shear type stirrer (multi-stage inline disperser: DRS 2000/5, manufactured by IKA Co.) to obtain a suspension in which droplets of the core mixture are dispersed. Then, 1 part by mass of sodium tetraborate decahydrate as a dispersion stabilizer was further added to the suspension.

After the suspension was encased in a reaction vessel equipped with a stirring blade and a temperature control device, a polymerization reaction was performed to form core particles. The temperature of the suspension in the polymerization reaction was controlled to about 85° C.

After the completion of the polymerization reaction of the core mixture, a water dispersion of the shell monomer and 0.2 parts by mass of 2,2′-azobis[2-methyl-N(2-hydroxyethyl)-propionamide] (water soluble polymerization initiator, trade name: VA-086 manufactured by Wako Pure Chemical Industries, Ltd.) were added to the reaction vessel. A water dispersion of core-shell type polymer particles was obtained by polymerizing the shell monomer for 4 hours.

The resulting water dispersion of the core-shell type polymer particles were washed, filtered and then dried to obtain toner particles. Cleaning, filtration and drying were performed by the following procedure.

First, acid washing was performed by adding sulfuric acid so as to adjust the pH to 4 or less while stirring the resulting water dispersion of the core-shell type polymer particles. Then, water was separated by filtration. The resulting core-shell type polymer particles were washed with ion-exchange water and dehydrated. Furthermore, washing with water and dehydration were repeated several times and then the core-shell type polymer particles were separated by filtration. The separated core-shell type polymer particles were dried at 45° C. for 48 hours to obtain toner particles.

The resulting toner particles had a volume average particle size of 7.0 μm and average circularity of 0.985.

### (External Addition Treatment Step)

To 100 parts by mass of toner particles, 1 part by mass of hydrophobic silica (trade name: TG820F, manufactured by Cabot Co.) and 0.4 parts by mass of titanium oxide (trade name: TAF-510P, manufactured by Fuji Titanium Industry Co., Ltd.) were added and then a stirring treatment was performed to obtain a toner. The stirring treatment was performed under the conditions of a circumferential speed 10 m/s for 20 minutes using a Henschel mixer (mixing blade type: weak shear blade ST-AO, manufactured by Mitsui Mining Co., Ltd.).

The resulting toner particles and the toner obtained by the external addition step were observed at a scanning width measuring 2×2 μm and a magnification of 5,000 times using SEM to obtain an electron micrograph.

It was confirmed from the resulting electron micrograph that about one to four small depressed portions are formed on the surface of the shell layer of toner particles per one toner particle. It was also confirmed that the small depressed portion(s) has/have a size of a diameter of about 0.5 to 1 μm. Also, it was confirmed that the external additive is dominantly distributed in the small depressed portion (s).

By an image forming apparatus as shown in FIG. 2, 5,000 and 10,000 copies were continuously printed using a color original copy of a printing area rate of 5% (A4). In both cases after 5,000 copies were continuous printed and 10,000 copies were continuous printed, fusion of the toner onto the developing roller was not observed.

### Example 2

In the same manner as in Example 1, except that 5 parts by mass of a low molecular weight polypropylene was mixed in place of mixing 3 parts by mass of the low molecular weight polypropylene in the preparation of the core mixture, a toner was produced and observed by SEM. Also, 5,000 and 10,000 copies were continuously printed.

It was confirmed from the resulting electron micrograph that about one to six small depressed portions are formed on the surface of the shell layer of toner particles per one toner particle. It was also confirmed that the small depressed portion(s) has/have a size of a diameter of about 0.5 to 1 μm. Also, it was confirmed that the external additive is dominantly distributed in the small depressed portion (s). In both cases after 5,000 copies were continuously printed and 10,000 copies were continuously printed, fusion of the toner onto the developing roller was not observed.

### Example 3

In the same manner as in Example 1, except that a stirring treatment was performed under the conditions of a circumferential speed of 30 m/s for 5 minutes was performed using a Henschel mixer equipped with a strong shear blade in place of performing a stirring treatment under the conditions of a circumferential speed of 10 m/s for 20 minutes using a Henschel mixer equipped with a weak shear blade in the external addition step, a toner was produced and observed by SEM. Also, 5,000 and 10,000 copies were continuously printed.

It was confirmed from the resulting electron micrograph that about one to small depressed portions are formed on the surface of the shell layer of toner particles per one toner particle. It was also confirmed that the small depressed portion(s) has/have a size of a diameter of about 0.5 to 1 μm. Also, it was confirmed that the external additive is dominantly distributed in the small depressed portion (s). However, the amount per unit area of the external additive existing on the surface of the small depressed portion(s) was less than that in case of the toner of Example 1. After 5,000 copies were continuously printed, fusion of the toner onto the developing roller was not observed. After 10,000 copies were continuously printed, slight fusion of the toner, which does not exert an adverse influence on image quality, occurred.

### Example 4

In the same manner as in Example 1, except that 5 parts by mass of the low molecular weight polypropylene was mixed in place of mixing 3 parts by mass of the low molecular weight polypropylene in the preparation of the mixed monomer solution and a stirring treatment was performed under the conditions of a circumferential speed of 30 m/s for 5 minutes using a Henschel mixer equipped with a strong shear blade in place of performing a stirring treatment under the conditions of a circumferential speed of 10 m/s for 20 minutes using a Henschel mixer equipped with a weak shear blade in the external addition step, a toner was produced and observed by SEM. Also, 5,000 and 10,000 copies were continuously printed.

It was confirmed from the resulting electron micrograph that about one to four small depressed portions are formed on the surface of the shell layer of toner particles per one toner particle. It was also confirmed that the small depressed portion(s) has/have a size of a diameter of about 0.5 to 1 μm. Also, it was confirmed that the external additive is dominantly distributed in the small depressed portion(s). However, the number of particle per unit area of the external additive existing in the small depressed portion(s) was less than that in case of the toner of Example 1. After 5,000 copies were continuously printed, fusion of the toner onto the developing roller was not observed. After 10,000 copies were continuously printed, slight fusion of the toner, which does not exert an adverse influence on image quality, occurred.

### Comparative Example 1

In the same manner as in Example 1, except that a stirring treatment was performed under the conditions of a circumferential speed of 30 m/s for 20 minutes using a Henschel mixer equipped with a strong shear blade in place of performing a stirring treatment under the conditions of a circumferential speed of 10 m/s for 20 minutes using a Henschel mixer equipped with a weak shear blade in the external addition step, a toner was produced and observed by SEM. Also, 5,000 and 10,000 copies were continuously printed.

It was confirmed from the resulting electron micrograph that although small depressed portions are formed on the surface of the shell layer of toner particles, the external additive was not dominantly distributed in the small depressed portions and was embedded in the shell layer. In both cases after 5,000 copies were continuously printed and 10,000 copies were continuously printed, a comparatively large amount of fusion of the toner, which exerts an adverse influence on image quality, occurred.

### Comparative Example 2

In the same manner as in Example 1, except that the low molecular weight polypropylene was not mixed in the preparation of the mixed monomer solution, toner was produced and observed by SEM. Also, copies were continuously printed. It was confirmed from the resulting electron micrograph that no small depressed portion was observed on the surface of the shell layer of toner particles. After 5,000 copies were continuously printed, a high temperature offset phenomenon occurred, and thus the subsequent evaluation was stopped.

Evaluation results of the Examples and the Comparative Examples are shown in Table 1.

TABLE 1

| | Low molecular | | | | | | |
|---|---|---|---|---|---|---|---|
| | weight | | | | | Toner fusion | |
| | polypropylene | Circumferential | Stirring | Blade | Adhesion state of external | 5,000 | 10,000 |
| | (parts by mass) | speed (m/s) | time (min) | type | additive | copies | copies |
| Example 1 | 3 | 10 | 20 | Weak | Large amount of uneven | Not | Not |
| | | | | shear | distribution in depressed portion | occurred | occurred |
| Example 2 | 5 | 10 | | blade | Large amount of uneven | Not | Not |
| | | | | | distribution in depressed portion | occurred | occurred |
| Example 3 | 3 | 30 | 5 | Strong | dominantly distributed slightly | Not | Slightly |
| | | | | shear | in depressed portion | occurred | occurred |
| Example 4 | 5 | 30 | | blade | dominantly distributed slightly | Not | Slightly |
| | | | | | in depressed portion | occurred | occurred |
| Comparative | 3 | 30 | 20 | Strong | Embedded | Occurred | Occurred |
| Example 1 | | | | shear | | | |
| | | | | blade | | | |
| Comparative | 0 | 10 | 20 | Weak | No depressed portion | High | Stopped |
| Example 2 | | | | shear | | temperature | after |
| | | | | blade | | offset | printing |
| | | | | | | occurred | 5,000 |
| | | | | | | | copies |

In Examples 1 and 2, toner fusion was not observed. The reason is considered as follows. Namely, the external additive adhered onto the small depressed portion(s) of the surface of the shell layer decreased oozing of the releasant, or adsorbed or held the oozed releasant, and also relieving stress applied to the small depressed portion.

In Examples 3 and 4, slight fusion of the toner, which does not exert an adverse influence on image quality, occurred.

In Comparative Example 1 and Comparative Example 2, fusion of the toner, which exerts an adverse influence on image quality, occurred. Particularly in Comparative Example 2, a high temperature offset phenomenon occurred after printing 5,000 copies. The reason is considered that the toner of Comparative Example 2 did not contain the low molecular polypropylene, which is a wax.

An aspect of the present invention described above pertains to a toner comprising core-shell type toner particles and an external additive, wherein the core-shell type toner particle has a core particle and a shell layer coating the core particle, the core particle contains a binder resin, a releasant and a coloring material, the shell layer has at least one small depressed portion on the surface there of, and the external additive is dominantly distributed in the one or more small depressed portion(s). The number of particle per unit area of the external additive existing in the small depressed portion(s) is preferably more than the number of particle per unit area of the external additive existing on the surface other than the small depressed portion. More specifically, the number of particle per unit area of the external additive existing in the small depressed portion(s) is preferably at least two times more than the number of particle per unit area of the external additive existing on the surface other than the small depressed portion (s). According to such a toner, it is possible to decrease the amount of the toner fused onto a developing roller and a regulating blade in a development process using a toner containing core-shell type toner particles.

The external additive preferably contains silica fine particles in view of a high effect of decreasing fusion of the toner.

The releasant preferably contains a polyolefin wax in view of easily forming the small depressed portion(s).

Another aspect of the present invention pertains to a method for producing a toner comprising a step of mixing core-shell type toner particles and an external additive, wherein the core-shell type toner particle has a core particle and a shell layer coating the core particle, in which the shell layer has at least one small depressed portion on the surface, and an external additive is mixed with stirring so that the external additive is dominantly distributed in the small depressed portion(s). According to the toner obtained by such a method, it is possible to decrease the amount of a toner fused onto a developing roller and a regulating blade in a development process using a toner containing core-shell type toner particles.

Another aspect of the present invention pertains to an image forming apparatus, comprising a non-magnetic one-component toner developing device using a full toner detection method of controlling the amount of a toner in a toner tank to a fixed amount, wherein the above toner is encased in the toner tank. Such an image forming apparatus has an advantage that fusion of a toner onto a developing roller and a regulating blade does not easily occur in a development process.

This application is based on patent application No. 2007-014867 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A toner comprising core-shell type toner particles and an external additive, wherein
the core-shell type toner particle has a core particle and a shell layer coating the core particle,
the core particle contains a binder resin, a releasant and a coloring material,
the shell layer has at least one small depressed portion on the surface there of, and
the external additive is dominantly distributed in the one or more small depressed portion(s).

2. The toner according to claim 1, wherein the number of particle per unit area of the external additive existing in the small depressed portion(s) is more than the number of particle per unit area of the external additive existing on the surface other than the small depressed portion(s).

3. The toner according to claim 1, wherein the number of particle per unit area of the external additive existing in the small depressed portion(s) is at least two times more than the number of particle per unit area of the external additive existing on the surface other than the small depressed portion(s).

4. The toner according to claim 1, wherein the external additive contains silica fine particles.

5. The toner according to claim 1, wherein the releasant contains a polyolefin wax.

6. A method for producing a toner comprising a step of mixing core-shell type toner particles and an external additive, wherein
the core-shell type toner particle has a core particle and a shell layer coating the core particle, in which the shell layer has at least one small depressed portion on the surface, and
an external additive is mixed with stirring so that the external additive is dominantly distributed in the small depressed portion (s).

7. An image forming apparatus comprising a non-magnetic one-component toner developing device using a full toner detection method of controlling an amount of a toner in a toner tank to a fixed amount, wherein the toner according to claim 1 is encased in the toner tank.
